(19) United States
(12) Patent Application Publication
(10) Pub. No.: US 2024/0052236 A1
(43) Pub. Date: Feb. 15, 2024

(54) QUANTUM DOT PARTICLE AGGREGATE AND PREPARATION METHOD THEREFOR, PREPARATION METHOD FOR LIGHT CONVERSION DEVICE, AND QUANTUM DOT PARTICLES

(71) Applicant: Najing Technology Corporation Limited, Hangzhou, Zhejiang (CN)

(72) Inventors: Shirong YU, Hangzhou, Zhejiang (CN); Fei ZHAO, Hangzhou, Zhejiang (CN); Jun BAI, Hangzhou, Zhejiang (CN); Fei LUO, Hangzhou, Zhejiang (CN); Yukai SU, Hangzhou, Zhejiang (CN); Yongyin KANG, Hangzhou, Zhejiang (CN); Zhen TAO, Hangzhou, Zhejiang (CN)

(21) Appl. No.: 18/270,867

(22) PCT Filed: Mar. 1, 2022
(86) PCT No.: PCT/CN2022/078523

§ 371 Date: Jul. 5, 2023

(30) Foreign Application Priority Data
Mar. 2, 2021 (CN) 202110230081.4
Jun. 10, 2021 (CN) 202110650160.0

(51) Int. Cl. C09K 11/02; C08J 3/12; C08L 33/12

(52) U.S. Cl. CPC C09K 11/02; C08J 3/126; C08L 33/12; B82Y 20/00

(57) ABSTRACT

The present disclosure provides a quantum dot particle aggregate and a preparation method therefor, a preparation method for a light conversion device, and quantum dot particles. The preparation method for the quantum dot particle aggregate includes: mixing a plurality of first polymer particles, a first quantum dot solution and a second polymer solution, and drying to obtain an aggregate containing a plurality of quantum dot particles A, where each of the quantum dot particles A includes a core of a first polymer particle and a shell of a second polymer formed by the second polymer, a plurality of first quantum dots are positioned in the shell of the second polymer, and the first polymer particle has a minimum dimension greater than or equal to 0.3 mm. The process reduces the damage to quantum dots and can prolong the life time of application products of quantum dots.

### TECHNICAL FIELD

The present disclosure relates to the technical field of quantum dot application, and in particular to a quantum dot particle aggregate and a preparation method therefor, a preparation method for a light conversion device, and quantum dot particles.

### BACKGROUND

Quantum dot-based light conversion devices are used as backlight components in the display field to improve the color performance of display devices. The existing mainstream product takes the form of a quantum dot film, which includes two barrier films and a quantum dot layer. However, quantum dot films are still costly. Recently, a quantum dot diffusion plate integrating functions of quantum dots and diffusion plate is put forward. According to the processing technology of the quantum dot diffusion plate, firstly, the quantum dots and polymer materials (blank materials) need to be mixed for granulation. However, the quantum dots are liable to damage by high temperature (200° C.+) required for the granulation process, which causes the technical problems of low light output efficiency and short life time in the quantum dot diffusion plate prepared.

### SUMMARY

An objective of the present disclosure is to provide a quantum dot particle aggregate and a preparation method therefor, a preparation method for a light conversion device, and quantum dot particles, so as to improve the performance of the quantum dot particles and the aggregate, and further improve the light output and lifetime performance of a light conversion device. According to the first aspect of present disclosure, a preparation method for a quantum dot particle aggregate is provided, the preparation method includes: mixing a plurality of first polymer particles, a first quantum dot solution and a second polymer solution, and drying to obtain an aggregate containing a plurality of quantum dot particles A, each of the quantum dot particles A includes a core of a first polymer particle and a shell of a second polymer formed by the second polymer, a plurality of first quantum dots are positioned in the shell of the second polymer, and the first polymer particle has a minimum dimension greater than or equal to 0.3 mm.

Optionally, the preparation method further includes: crushing the aggregate containing a plurality of quantum dot particles A to obtain the plurality of quantum dot particles A, mixing the plurality of quantum dot particles A and a third polymer solution, and drying to obtain an aggregate containing a plurality of quantum dot particles B, each of the quantum dot particles B includes a core of the quantum dot particle A and a shell of a third polymer formed by the third polymer.

Optionally, the preparation method further includes: crushing the aggregate including a plurality of quantum dot particles A to obtain the plurality of quantum dot particles A, mixing the plurality of quantum dot particles A, a second quantum dot solution and a third polymer solution, and drying to obtain an aggregate containing a plurality of quantum dot particles B′, each of the quantum dot particles B′ includes a core of the quantum dot particle A and a shell of a third polymer formed by the third polymer, and a plurality of second quantum dots are positioned in the shell of the third polymer.

Optionally, the preparation method further includes: crushing the aggregate containing a plurality of quantum dot particles B to obtain the plurality of quantum dot particles B, mixing the plurality of quantum dot particles B, a second quantum dot solution and a fourth polymer solution, and drying to obtain an aggregate containing a plurality of quantum dot particles C, each of the quantum dot particles C includes a core of the quantum dot particle B and a shell of a fourth polymer formed by the fourth polymer, and a plurality of second quantum dots are positioned in the shell of the fourth polymer.

Optionally, the fourth polymer includes one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer, and polyethylene terephthalate.

Optionally, the second quantum dot solution includes 0.1 wt % to 5 wt % of the second quantum dots, and the second quantum dots are the same as or different from the first quantum dots.

Optionally, a mass ratio of the plurality of first polymer particles to the second polymer is 100:1 to 100:10, and a mass ratio of the first quantum dots to the second polymer is 0.1:100 to 5:100.

Optionally, the first quantum dot solution includes 0.1 wt % to 5 wt % of the first quantum dots.

Optionally, the first polymer particle has a shape of a cylinder or a cuboid.

Optionally, the first polymer particle includes one or more of polystyrene, polymethylmethacrylate, polypropylene, polyethylene, an acrylonitrile-styrene copolymer, a methyl methacrylate-styrene copolymer, polycarbonate, and polyethylene terephthalate.

Optionally, the second polymer or the third polymer includes one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer, and polyethylene terephthalate.

According to the second aspect of present disclosure, a preparation method for a light conversion device is provided, the preparation method includes: obtaining the quantum dot particle aggregate according to the preparation method of any one above, subjecting the quantum dot particle aggregate to crushing treatment or not, melt-extruding, and solidifying and molding to obtain the light conversion device.

According to the third aspect of present disclosure, a quantum dot particle is provided, the quantum dot particle includes a core of a first polymer particle and a shell of a second polymer, a plurality of first quantum dots are positioned in the shell of the second polymer, and the first polymer particle has a minimum dimension greater than or equal to 0.3 mm.

Optionally, the core of the first polymer particle is non-chemically bonded to the shell of the second polymer.

Optionally, the quantum dot particle further includes a shell of a third polymer, the shell of the third polymer is positioned outside the shell of the second polymer.

Optionally, the quantum dot particle further includes a shell of a third polymer, the shell of the third polymer is positioned outside the shell of the second polymer, and a plurality of second quantum dots are positioned in the shell of the third polymer.

Optionally, the quantum dot particle further includes a shell of a fourth polymer, the shell of the fourth polymer is positioned outside the shell of the third polymer.

Optionally, the quantum dot particle has a fluorescence quantum efficiency greater than or equal to 90%, and the quantum dot particle has a full-width at half maximum less than or equal to 25 nm. Optionally, the first polymer is the same as or different from the second polymer.

Optionally, the second polymer is the same as or different from the third polymer.

Optionally, the first polymer particle includes one or more of polystyrene, polymethylmethacrylate, polypropylene, polyethylene, an acrylonitrile-styrene copolymer, a methyl methacrylate-styrene copolymer, polycarbonate, and polyethylene terephthalate; the second polymer or the third polymer includes one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer and polyethylene terephthalate; and the fourth polymer includes one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer and polyethylene terephthalate.

According to the fourth aspect of present disclosure, a quantum dot particle aggregate is provided, the quantum dot particle aggregate includes a plurality of the quantum dot particles of any one above, the quantum dot particles are dispersed in a polymer matrix, and the material of the polymer matrix is the same as the polymer of an outermost shell of the quantum dot particle.

Optionally, the quantum dot particles are non-chemically bonded to the polymer matrix. Optionally, impact resistance of the polymer matrix between the quantum dot particles is less than or equal to 2.1 kJ/m².

Compared with the traditional preparation process of quantum dot particles, the embodiment of the method for preparing the quantum dot particle aggregate has the advantages that quantum dots and blank polymer materials are not mixed and subjected to high-temperature extrusion granulation, so that the damage of the high-temperature process to the quantum dots is avoided, and the life time of an application product can be prolonged; and the prepared quantum dot particle aggregate can be directly used for preparing a quantum dot-based light conversion device or can be used for preparing the quantum dot-based light conversion device after conducting a crushing process, so that the preparation process of the quantum dot particle aggregate is simple and less costly. In addition, the first polymer particles are used as a carrier for loading quantum dots, where the first polymer particles with a larger dimension lay a foundation for the dimension of the quantum dot particles, and the quantum dot particles with a larger dimension are beneficial for uniform mixing of luminescent materials, which can improve the uniformity of the melted co-extruded material in the preparation method for the light conversion device, and thus improve the light-emitting uniformity of the light conversion device.

### BRIEF DESCRIPTION OF THE DRAWINGS

The accompany drawings constituting a part of the present disclosure are intended to provide further understanding of the present disclosure. The exemplary embodiments of the present disclosure and illustrations thereof are used to explain the present disclosure and do not constitute an undue limitation to the present disclosure. In the accompanying drawings:

FIG. 1 shows an external view and a cross-sectional top view of a single-shell quantum dot particle.

FIG. 2 shows an external view and a cross-sectional top view of a dual-shell quantum dot particle.

FIG. 3 shows a cross-sectional view of a quantum dot particle aggregate.

FIG. 4 shows a cross-sectional view of a microaggregate formed after the quantum dot particle aggregate is crushed.

FIG. 5 shows a photograph of a quantum dot particle obtained according to a preparation method of an example.

FIG. 6 shows a photograph of a quantum dot particle obtained according to a preparation method of a comparative example.

### DETAILED DESCRIPTION

It should be noted that the following detailed descriptions are all exemplary and are intended to provide further explanation of the present disclosure. Unless otherwise stated, all technical and scientific terms used herein have the same meanings as that commonly understood by those of ordinary skill in the art to which the present disclosure belongs.

It should be noted that the terms “first”, “second”, “A”, “B”, and so on in the specification and claims of the present disclosure are intended to distinguish between similar objects but do not necessarily describe a specific order or sequence. It should be understood that, the data termed in such a way are interchangeable in proper circumstances so that the examples of the present disclosure described herein can be implemented in other orders than the order illustrated or described herein. Moreover, the terms “include”, “contain”, and any other variants mean to cover the non-exclusive inclusion, for example, a process, method, system, product, or device that includes a list of steps or units is not necessarily limited to those steps or units which are clearly listed, but may include other steps or units which are not expressly listed or inherent to such a process, method, system, product, or device.

The following will give detailed descriptions about exemplary implementations of a quantum dot particle aggregate and a preparation method therefor, a preparation method for a light conversion device, and quantum dot particles according to the present disclosure. These exemplary implementations may, however, be implemented in many different forms and should not be construed as being limited to the implementations set forth herein. It should be understood that, these implementations are provided to make the present disclosure thorough and complete, and to fully convey the concept manifested in these exemplary implementations to those of ordinary skill in the art.

As described in the background art, the quantum dot-based light conversion device in the prior art has poor performance, and a process is required to maintain the original performance of the quantum dots or reduce the deterioration of the original performance of the quantum dots. The inventors believe that the high-temperature process used during granulation of quantum dot particles in the prior art causes damage to the quantum dots, and therefore, there is a need to reduce damage caused by high temperature. Therefore, according to a first aspect of the present disclosure, a preparation method for a quantum dot particle aggregate is provided, including: mixing a plurality of first polymer particles, a first quantum dot solution and a second polymer solution, and drying to obtain an aggregate containing a plurality of quantum dot particles A, where each of the quantum dot particles A includes a core of a first polymer particle and a shell of a second polymer formed by the second polymer, a plurality of first quantum dots are positioned in the shell of the second polymer, and the first polymer particle has a minimum dimension greater than or equal to 0.3 mm.

Compared with the traditional preparation process of quantum dot particles, the present disclosure has the advantages that quantum dots and blank polymer materials are not mixed and subjected to high-temperature extrusion granulation, so that the damage of high temperature to the quantum dots is avoided. The quantum dot particle aggregate can be directly used for preparing a quantum dot-based light conversion device or can be used for preparing the quantum dot-based light conversion device after being slightly crushed, so that the preparation method is simple in process and low in cost. In addition, the larger first polymer particles lay a foundation for the dimension of the quantum dot particles, and an aggregate of the larger quantum dot particles is beneficial for uniform mixing of luminescent materials (with nanoscale), which improves the uniformity of the melted co-extruded material, and thus improves the light-emitting uniformity of the final light conversion device.

In the present disclosure, “polymer solution” means that a polymer is dispersed in a solvent in the form of molecular chains. The above-mentioned “minimum dimension” refers to a length of a shortest line segment of any cross section of the first polymer particle. The following “maximum dimension” refers to a length of a longest line segment of any cross-section of the first polymer particle. The above “plurality” modifies only the first polymer particle.

In some embodiments, in the process of mixing a plurality of first polymer particles, a first quantum dot solution and a second polymer solution and then conducting drying, the first quantum dot solution and the second polymer solution can be first mixed to produce a mixed solution, which is then mixed with the first polymer particles.

In some embodiments, the first polymer particle may or may not have micropores, and quantum dots may or may not enter the micropores.

In some embodiments, the first polymer particle has a minimum dimension greater than or equal to 1 mm. In some embodiments, the first polymer particle has a minimum dimension of 0.3 mm to 10 mm, or 0.5 mm to 10 mm. In some embodiments, the first polymer particle has a minimum dimension of 1 mm to 20 mm, or 1 mm to 10 mm, or 1 mm to 8 mm. In some embodiments, the first polymer particle has a maximum dimension of 2 mm to 30 mm, or 2 mm to 20 mm, or 2 mm to 10 mm, or 5 mm to 10 mm. In some preferred embodiments, the first polymer particle has an average dimension (average of the maximum dimension and the minimum dimension) of 2 mm to 5 mm.

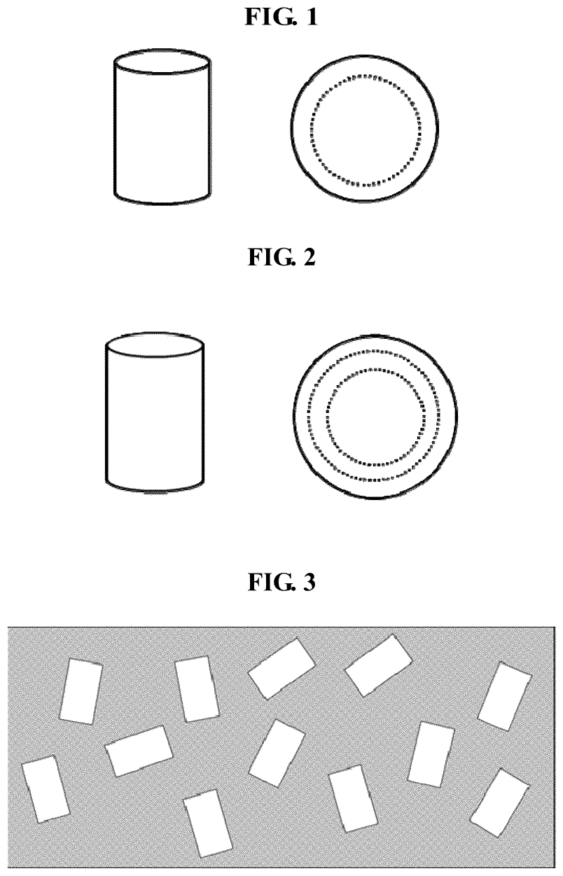

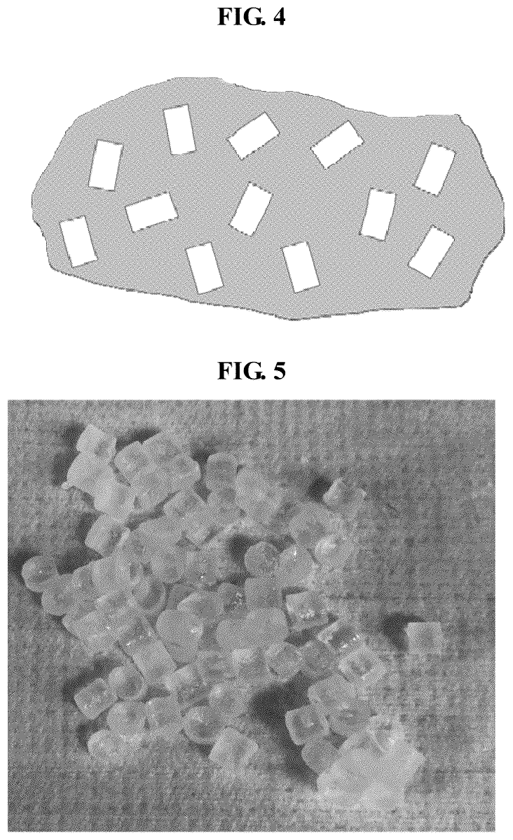

The structural schematic diagram of the quantum dot particle A is shown in FIG. 1, and the dotted line represents the boundary of shells. Whether the dimension of the quantum dot particles A obtained in the subsequent operation is uniform or not is related to the preparation process, and the quantum dot particles A can be adjusted to a relatively uniform dimension distribution state, as shown in the photograph of FIG. 5.

It should be noted that, the quantum dot particle aggregate refers to an aggregate of a plurality of quantum dot particles. In one embodiment of the aggregate of the quantum dot particles A, a plurality of first polymer particles are dispersed in a second polymer, and the molecular chains of the second polymer coat all the first polymer particles, as shown in FIG. 3. At this time, there is no boundary between the quantum dot particles A (it is thought that a plurality of quantum dot particles A are contained therein, and an additional force is required to conduct a separation operation such as a crushing operation and obtain the plurality of quantum dot particles A). In other embodiments, the quantum dot particle aggregate prepared may be comprised of a plurality of parts, such as a plurality of microaggregates, or a plurality of microaggregates and a plurality of quantum dot particles A. The term “microaggregate” is a relative concept and refers to an aggregate containing a relatively small number (greater than or equal to 2) of quantum dot particles.

The distance between the molecular chains of a second polymer is greater than the distance between the molecular chains of a first polymer due to the presence of the first polymer particles. The distance between molecular chains can also influence the entanglement between molecular chains: entanglement occurs only when the distance between molecular chains is smaller than a given radius of rotation. Therefore, the intermolecular force of the first polymer is generally greater than that of the second polymer. In some embodiments, the aggregate of quantum dot particles A can be subjected to simple crushing treatment, such as natural crushing (without artificially applied force), so that a plurality of quantum dot particles A and/or a microaggregate containing a plurality of quantum dot particles A can be separated, and the quantum dot particles A may have same or different dimensions and regular or irregular shapes and dimension/shape difference or irregularity can reduce the difficulty in preparing quantum dot particles. The quantum dot particles A or the microaggregate (containing a less number of the first polymer particles than the original aggregate) can be directly melted in an extruder without an additional step for preparing a light conversion device, so that the production cost is reduced. In order to conveniently separate the quantum dot particles A from the aggregate, it is generally required to consider the type, molecular weight and particle dimension and shape of the first polymer of the initial first polymer particles, and the type and molecular weight of the second polymer, since these factors may influence the interaction force between the polymers that needs to be overcome during the separation process. Those skilled in the art can select a suitable polymer material for this purpose.

In some embodiments, after the drying process is completed, molecular chains are re-entangled and combined to form a second polymer. However, internal connection force (intermolecular force and partial chemical bonds) of the second polymer is weak, so that the aggregate naturally splits (instead of being caused by pressure intentionally applied), and a plurality of quantum dot particle microaggregates with a smaller volume are formed, or a plurality of single quantum dot particles appear, in a colloquial way, a phenomenon of “slag drop” occurs to the quantum dot aggregate. These quantum dot particle aggregates or quantum dot particles with different volumes can be used as raw materials for preparing a light conversion device.

In some embodiments, quantum dots are not included in the raw materials of the first polymer particles. In some embodiments, the light transmittance of the first polymer particles is greater than or equal to 70%, or the light transmittance of the first polymer particles is greater than or equal to 80%. The light transmittance of the second polymer is greater than or equal to 70%, or the light transmittance of the second polymer is greater than or equal to 80%.

In a preferred embodiment, the solvent in the second polymer solution and the solvent of the first quantum dot solution are miscible. In this way, the quantum dots can be better dispersed into the second polymer. The boiling point of both solvents is less than or equal to 150° C., which facilitates low-temperature drying.

The above-mentioned drying does not cause 100% volatilization of the solvent, and a portion of the solvent may be left as long as the remaining amount does not affect subsequent processing. The above-mentioned drying may be carried out in multiple stages, such as preliminary drying, followed by complete drying.

In some embodiments, the above-mentioned first quantum dot solution and second polymer solution are a solution containing both quantum dots and a polymer.

In some embodiments, the solvent in the second polymer solution may moderately dissolve the first polymer particles, so that the first polymer particles have the first polymer on the surface, and the molecular chains of the first polymer on the outermost side of the first polymer particles and the second polymer in the second polymer solution are entangled with each other, thereby making the second polymer more firmly coat the first polymer particles. It should be noted that, although the solvent in the second polymer solution can dissolve the first polymer particles, the first polymer particles can be partially dissolved instead of being completely dissolved simply by controlling the time and the type/amount of the solvent. Meanwhile, the “core of a first polymer particle” in the above “quantum dot particle A includes a core of a first polymer particle and a shell of a second polymer formed by polymerizing a second polymer precursor” refers to a first polymer particle which has a dissolved (or etched) surface, and is slightly different from the raw first polymer particle, and the “shell” is not purely the second polymer. However, it should be understood that, this case is also within the scope of protection of the present disclosure.

In other embodiments, the solvent in the second polymer solution may not dissolve the first polymer particles, so that the second polymer does not coat the first polymer particles as strongly as the extent to which the molecular chains of the above-mentioned two polymers are entangled.

In some embodiments, the shell of the second polymer may completely coat the core of the first polymer particles, or may partially coat the first polymer particles, or both cases exist.

In some embodiments, the aggregate containing a plurality of quantum dot particles A is crushed to obtain a plurality of quantum dot particles A, the plurality of quantum dot particles A and a third polymer solution are mixed, and drying is conducted to obtain an aggregate containing a plurality of quantum dot particles B, where each of the quantum dot particles B includes a core of a quantum dot particle A and a shell of a third polymer formed by the third polymer.

The above-mentioned crushing includes the step of applying external force to crack the aggregate to obtain a plurality of quantum dot particles A, so as to prepare for the next step of coating a third polymer; since the second polymer is an existing polymer and is not obtained by the polymerization reaction in the aggregate preparation process, the molecular chains of the second polymer do not have strong internal connection force and are easily cracked. Further protection of the quantum dots is achieved through coating of the polymer shell. It should be noted that “crushing” mentioned in the present disclosure includes crushing by external force that is not manipulated by a man, that is, both natural crushing and artificial crushing are included. In some embodiments, the magnitude of crushing force in the artificial crushing ranges from 50 kgf to 120 kgf. In addition, although the present disclosure uses the expression “mixing material 1 and material 2 and conducting drying”, the raw material for preparing the aggregate may also include other materials, and is not limited to material 1 and material 2. For example, in some embodiments, an aggregate containing a plurality of quantum dot particles A is crushed to obtain a plurality of quantum dot particles A and a microaggregate E of a plurality of quantum dot particles A, the plurality of quantum dot particles A, the microaggregate E of a plurality of quantum dot particles A, and the third polymer solution are mixed, then drying is conducted to obtain an aggregate containing a plurality of quantum dot particles B, and each of the quantum dot particles B includes a core of a quantum dot particle A and a shell of a third polymer formed by the third polymer. Meanwhile, the quantum dot particle aggregate further includes a microaggregate F with the microaggregate E of a plurality of quantum dot particles A as a core, and the third polymer as a shell.

In some embodiments, the shell of the third polymer has a thickness of 0.1 mm to 3 mm. In some embodiments, the shell of the third polymer may completely coat the core, or may partially coat the core.

In some embodiments, the aggregate containing a plurality of quantum dot particles A is crushed to obtain a plurality of quantum dot particles A, the plurality of quantum dot particles A, the second quantum dot solution and the third polymer solution are mixed, and drying is conducted to obtain an aggregate containing a plurality of quantum dot particles B′, where each of the quantum dot particles B′ includes a core of a quantum dot particle A and a shell of a third polymer formed by the third polymer, and the plurality of second quantum dots are positioned in the shell of the third polymer. In some embodiments, the shell of the third polymer has a thickness of 0.1 mm to 3 mm.

In some embodiments, the aggregate containing a plurality of quantum dot particles A is crushed to obtain a plurality of quantum dot particles A and a microaggregate E of a plurality of quantum dot particles A, the plurality of quantum dot particles A, the microaggregate E of a plurality of quantum dot particles A, the second quantum dot solution and the third polymer solution are mixed, then drying is conducted to obtain an aggregate containing a plurality of quantum dot particles B′, and each of the quantum dot particles B′ includes a core of a quantum dot particle A and a shell of a third polymer formed by the third polymer, and the plurality of second quantum dots are positioned in the shell of the third polymer. Meanwhile, the aggregate further contains a microaggregate F with the microaggregate E of a plurality of quantum dot particles A as the core, and the third polymer as the shell, where the plurality of second quantum dots are positioned in the shell of the third polymer.

In some embodiments, the third polymer has a light transmittance greater than or equal to 70%, or the third polymer has a light transmittance greater than or equal to 80%.

In some embodiments, the aggregate containing a plurality of quantum dot particles B is crushed to obtain a plurality of quantum dot particles B, the plurality of quantum dot particles B, the second quantum dot solution and a fourth polymer solution are mixed, and drying is conducted to obtain an aggregate containing a plurality of quantum dot particles C, where each of the quantum dot particles C includes a core of a quantum dot particle B and a shell of a fourth polymer formed by the fourth polymer, and the plurality of second quantum dots are positioned in the shell of the fourth polymer. Further protection of the quantum dots is achieved through the shell of the fourth polymer. In some embodiments, the shell of the fourth polymer has a thickness of 0.1 mm to 3 mm.

In some embodiments, the fourth polymer has a light transmittance greater than or equal to 70%, or the fourth polymer has a light transmittance greater than or equal to 80%.

In some embodiments, any of the quantum dot particles described above is non-chemically bonded to the polymer matrix (e.g., second polymer, third polymer, fourth polymer), which makes it convenient to crush the aggregate and separate the quantum dot particles.

In some embodiments, the impact resistance of the polymer matrix between any of the above-mentioned quantum dot particles is less than or equal to 2.1 kJ/m².

In some embodiments, the first quantum dots in the first quantum dot solution and the second quantum dots in the second quantum dot solution may be completely the same, partially the same, or completely different. For example, they may have completely the same or partially the same, e.g., composition, emission wavelength, full-width at half maximum (FWHM), and processing technology. One or more types of quantum dots are contained in the first quantum dot solution, and one or more types of quantum dots are contained in the second quantum dot solution.

In some embodiments, polymers matching different types of quantum dots may vary, thus different quantum dots matching different polymers are processed into the same quantum dot particle aggregate by a two-step coating process. If the quantum dots are of the same type, the operation can also be conducted through the process.

In some embodiments, the above-mentioned mixing method is stirring. In some embodiments, the above-mentioned mixing is performed to achieve a uniform mixing state.

In some embodiments, the above-mentioned first quantum dot and the second quantum dot are not perovskite quantum dots, or graphene quantum dots, or carbon quantum dots, or silicon quantum dots, or germanium quantum dots.

In some embodiments, the above-mentioned quantum dot particle aggregate has a cadmium content less than or equal to 100 ppm.

In some embodiments, the fourth polymer includes one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer, and polyethylene terephthalate.

In some embodiments, the second quantum dot solution includes 0.1 wt % to 5 wt % of second quantum dots the same as or different from the first quantum dots.

In some embodiments, in the raw materials, the mass ratio of the plurality of first polymer particles to the second polymer is 100:1 to 100:10, and the mass ratio of the first quantum dots to the second polymer is 0.1:100 to 5:100.

In some embodiments, the first quantum dot solution includes 0.1 wt % to 5 wt % of first quantum dots.

In some embodiments, the first polymer particle has a shape of a cylinder or a cuboid. Regular first polymer particles are easier to process.

In some embodiments, the first polymer particle includes one or more of polystyrene, polymethylmethacrylate, polypropylene, polyethylene, an acrylonitrile-styrene copolymer, a methyl methacrylate-styrene copolymer, polycarbonate, and polyethylene terephthalate.

In some embodiments, the second polymer or third polymer includes one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer, and polyethylene terephthalate.

In some embodiments, the quantum dot particles (quantum dot particles A or B or B′ or C) have a fluorescence quantum efficiency greater than or equal to 90%, and a full-width at half maximum (FWHM) less than or equal to 25 nm.

In some embodiments, the first polymer is the same as or different from the second polymer. In some embodiments, the first polymer has a molecular weight of 30,000 to 600,000, and the second polymer has a molecular weight of 5,000 to 200,000.

In some embodiments, the second polymer is the same as or different from the third polymer. In some embodiments, the molecular weight of the second polymer is less than the molecular weight of the third polymer. In some embodiments, the second polymer has a molecular weight of 5,000 to 200,000, and the third polymer has a molecular weight of 10,000 to 300,000.

According to a second aspect of the present disclosure, a preparation method for a light conversion device is provided, including: obtaining a quantum dot particle aggregate according to any one of the above methods, subjecting the quantum dot particle aggregate to crushing treatment or not, melt-extruding, and solidifying and molding to obtain the light conversion device. The preparation method for the light conversion device avoids the damage of high temperature to quantum dot particles during preparation, and reduces the damage of high temperature to the quantum dots during the whole preparation process of the light conversion device, which improves the luminous efficiency, and can realize the light-emitting uniformity of the light conversion device. It should be noted that, when the aggregate is not crushed, the dimension thereof should meet the requirements of a feeding inlet of an extruder for the dimension of fed materials.

Reference can be made to the prior art for the parameter conditions of the above-mentioned melt extrusion and solidification. The above-mentioned light conversion device may be used in a display apparatus or in an illuminating apparatus. The light conversion device may be in various shapes such as a film shape, a tube shape, and a plate shape.

According to a third aspect of the present disclosure, a quantum dot particle is provided, including a core of a first polymer particle and a shell of a second polymer, where a plurality of first quantum dots are positioned in the shell of the second polymer, and the first polymer particle has a minimum dimension greater than or equal to 0.3 mm. The quantum dot particle has a dimension suitable for the existing extrusion process and equipment, and convenient for uniform mixing, meanwhile the quantum dot particle has low manufacturing cost and can be uniformly distributed in the final product, and the luminous uniformity of the final product is further improved.

In some embodiments, the core of the first polymer particle does not include quantum dots. In some embodiments, the core of the first polymer particle is non-chemically bonded to the shell of the second polymer.

In some embodiments, the first polymer particle has a minimum dimension of 0.3 mm to 10 mm. In some embodiments, the first polymer particle has a minimum dimension of 1 mm to 20 mm, or 1 mm to 10 mm, or 1 mm to 8 mm. In some embodiments, the first polymer particle has a maximum dimension of 2 mm to 30 mm, or 2 mm to 20 mm, or 2 mm to 10 mm. In some preferred embodiments, the first polymer particle has an average dimension (average of the maximum dimension and the minimum dimension) of 2 mm to 5 mm.

In some embodiments, the quantum dot particle further includes a shell of a third polymer positioned outside the shell of the second polymer.

In some embodiments, the quantum dot particle further includes a shell of a third polymer positioned outside the shell of the second polymer, and the quantum dot particle further includes a plurality of second quantum dots positioned in the shell of the third polymer.

In some embodiments, the quantum dot particle further includes a shell of a fourth polymer positioned outside the shell of the third polymer. In other embodiments, the quantum dot particle having shells of four-layered polymers further includes n shells of polymers, where n is an integer greater than 4.

In some embodiments, the quantum dot particle has a fluorescence quantum efficiency greater than or equal to 90%, and the quantum dot particle has a full-width at half maximum (FWHM) less than or equal to 25 nm.

In some embodiments, the first polymer is the same as or different from the second polymer. In some embodiments, the first polymer has a molecular weight of 30,000 to 600,000, and the second polymer has a molecular weight of 5,000 to 200,000.

In some embodiments, the second polymer is the same as or different from the third polymer. In some embodiments, the molecular weight of the second polymer is less than the molecular weight of the third polymer.

In some embodiments, the second polymer has a molecular weight of 5,000 to 200,000, and the third polymer has a molecular weight of 1 to 300,000. The difference in the molecular weight of the polymer results in different internal connection forces of the molecular chains of the dissolved polymer which are reconnected after being dried, so that quantum dot particles with different dimensions can be obtained through adjustment.

In some embodiments, the polymer of the first polymer particles is of the same type as the second polymer, third polymer or fourth polymer, but has a different molecular weight, and the molecular weight of the first polymer in the first polymer particles is greater than the molecular weight of the second polymer, third polymer or fourth polymer. The first polymer particles maintain higher integrity than the second polymer, third polymer or fourth polymer, which are convenient for crushing and separating to obtain the quantum dot particles.

In some embodiments, the quantum dot particle has an average dimension of 1 mm to 8 mm. In some embodiments, the first polymer particle includes one or more of polystyrene, polymethylmethacrylate, polypropylene, polyethylene, an acrylonitrile-styrene copolymer, a methyl methacrylate-styrene copolymer, polycarbonate, and polyethylene terephthalate.

In some embodiments, the second polymer or third polymer includes one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer, and polyethylene terephthalate.

In some embodiments, the fourth polymer includes one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer, and polyethylene terephthalate.

In some embodiments, the polymer of the first polymer particle is of the same type as the second polymer, third polymer or fourth polymer, and are both polymethylmethacrylate.

According to a fourth aspect of the present disclosure, a quantum dot particle aggregate is provided, including a plurality of the quantum dot particles of any of the above types, where the quantum dot particles are dispersed in a polymer matrix, and the material of the polymer matrix is the same as the polymer of an outermost shell of the quantum dot particle.

In some embodiments, the quantum dot particle is non-chemically bonded to the polymer matrix. The quantum dot particle is conveniently separated from the aggregate.

In some embodiments, the impact resistance of the polymer matrix between the quantum dot particles is less than or equal to 2.1 kJ/m². The quantum dot particle is conveniently separated from the aggregate.

In some embodiments, there is a difference in dimension, or shape, or both dimension and shape, between the quantum dot particles.

The preparation method for the quantum dot particle aggregate and the preparation method for the light conversion device of the present disclosure are further described below with reference to examples.

### Example 1

First, polymethylmethacrylate (PMMA) was selected as the first polymer particle, with a molecular weight Mw of about 100,000, and an average particle dimension of about 3 mm. Then 1 wt % of quantum dot toluene solution (the mass ratio of red quantum dots to green quantum dots was 1:1.2) was taken, and uniformly mixed with 50 wt % of PMMA polymer (Mw was about 10,000) toluene solution according to a mass ratio of 1:10 to obtain a first quantum dot-PMMA toluene solution.

Next, the first polymer particles and the first quantum dot-PMMA toluene solution were mixed under stirring according to a mass ratio of 100:1, and at the same time, a toluene solvent was removed by vacuumizing to obtain a quantum dot particle aggregate with the first polymer particles connected through a quantum dot-PMMA polymer.

Finally, drying and separating operation was conducted: the quantum dot particle aggregate was subjected to vacuum drying at the temperature of 80° C. for 3 h to further remove residual solvent, the dried material was crushed and separated in a blender, and the rotating speed was set to 100 RPM to separate part of the aggregate into single granules, namely the final quantum dot particles A, where quantum dots were distributed in a shell with a thickness range of 0.01 mm to 0.1 mm, and the mass fraction of the quantum dots was about 0.2 wt %.

The quantum dot particle aggregate was made into a standard notched sample strip for cantilever impact tester according to the method of ISO 180, and the impact resistance of the sample strip was tested according to the standard test method, where the test value was 0.8 kJ/m².

### Example 2

The quantum dot particles A obtained in Example 1 were mixed with 50 wt % of PMMA oligomer (Mw of about 20,000) toluene solution under stirring according to a mass ratio of 100:1, at the same time, a toluene solvent was removed by vacuumizing, and the same drying and separating operation as that in example 1 was performed to obtain a quantum dot particle B with the first polymer particle as the core, the quantum dot (concentration being about 0.2 wt %)-PMMA as the first shell, and the PMMA without quantum dots as the second shell.

### Example 3

The difference between the present example and Example 2 lies in that firstly, 0.1 wt % of quantum dot toluene solution (the mass ratio of red quantum dots to green quantum dots was 1:1.2) and 50 wt % of PMMA oligomer (Mw being about 20,000) toluene solution were mixed uniformly according to a mass ratio of 1:10 to obtain a second quantum dot-PMMA toluene solution.

The quantum dot particles A and the second quantum dot-PMMA toluene solution were mixed and stirred uniformly according to a mass ratio of 100:1, and at the same time, a toluene solvent was removed by vacuumizing to obtain a quantum dot particle aggregate with the quantum dot particles A connected through a second quantum dot-PMMA oligomer.

Finally, the same drying and separating operation as that in Example 1 was performed to obtain a plurality of quantum dot particles B′ with the first polymer particles as the core, the quantum dot (about 0.2 wt %)-PMMA as the first shell, and the quantum dot (about 0.02 wt %)-PMMA as the second shell.

### Example 4

The difference between the present example and Example 2 lies in that firstly, 0.1 wt % of quantum dot toluene solution (the mass ratio of red quantum dots to green quantum dots was 1:1.2) and 50 wt % of polystyrene (PS) oligomer (Mw being about 20,000) toluene solution were mixed uniformly according to a mass ratio of 1:10 to obtain a third quantum dot-PS toluene solution.

The quantum dot particles A and the third quantum dot-PS toluene solution were mixed and stirred uniformly according to a mass ratio of 100:1, and at the same time, a toluene solvent was removed by vacuumizing to obtain a quantum dot particle aggregate with the quantum dot particles A connected through a third quantum dot-PS oligomer.

Finally, the same drying and separating operation as that in example 1 was performed to obtain a plurality of quantum dot particles C with the first polymer particles as the core, the PMMA (the mass fraction of quantum dots being about 0.2 wt %) as the first shell, and the quantum dot (about 0.02 wt %)-PS as the second shell.

### Example 5

First, PMMA was selected as the first polymer particle, with a molecular weight Mw of about 100,000, and an average particle dimension of about 3 mm.

Then 0.5 wt % of green quantum dot toluene solution and 50 wt % of PMMA polymer (Mw being about 10,000) toluene solution were mixed uniformly according to a mass ratio of 1:10 to obtain a fourth quantum dot-PMMA toluene solution.

Then 0.5 wt % of red quantum dot toluene solution and 50 wt % of PMMA polymer (Mw being about 10,000) toluene solution were mixed uniformly according to a mass ratio of 1:10 to obtain a fifth quantum dot-PMMA toluene solution.

First, the first polymer particles and the fourth quantum dot-PMMA toluene solution were mixed under stirring according to a mass ratio of 100:1, and at the same time, a toluene solvent was removed by vacuumizing to obtain a quantum dot particle aggregate 1 with the first polymer particles connected through a fourth quantum dot-PMMA polymer.

Drying and separating operation: the quantum dot particle aggregate 1 was subjected to vacuum drying at the temperature of 80° C. for 3 h to further remove residual solvent, the dried material was crushed and separated in a blender, and the rotating speed was set to 100 RPM to separate part of the quantum dot particle aggregate into single granules, namely the quantum dot particles containing a green quantum dot polymer shell, where green quantum dots were distributed in the polymer shell with a thickness range of 0.01 mm to 0.1 mm, and the mass fraction of the green quantum dots was about 0.1 wt %.

Next, the quantum dot particles obtained in the above step and the fifth quantum dot-PMMA toluene solution were mixed under stirring according to a mass ratio of 100:1, and at the same time, a toluene solvent was removed by vacuumizing to obtain a quantum dot particle aggregate 2 with the quantum dot particles connected through a fifth quantum dot-PMMA polymer.

Finally, drying and separating operation was conducted: the quantum dot particle aggregate 2 was subjected to vacuum drying at the temperature of 80° C. for 3 h to remove residual solvent, the dried material was crushed and separated in a blender, and the rotating speed was set to 100 RPM to separate part of the quantum dot particle aggregate 2 into single granules, namely quantum dot particles E′, where red quantum dots were distributed in a second shell with a thickness range of 0.01 mm to 0.1 mm, and had a mass fraction of about 0.1 wt %, and green quantum dots were distributed in a first shell with a thickness range of 0.01 mm to 0.1 mm, and had a mass fraction of about 0.1 wt %.

### Comparative Example 1

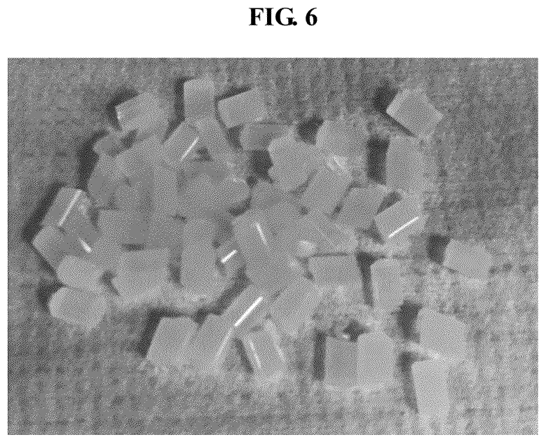

In a traditional granulation process, 1 wt % of quantum dot toluene solution (the mass ratio of red quantum dots to green quantum dots was 1:1.2) and a blank material PMMA (with a molecular weight of 100,000) were subjected to twin-screw extrusion granulation according to a ratio of 1:1,000, where the temperature was set to about 230° C., and the average dimension of the diced granules was about 3 mm. The resulting quantum dot polymer particles refer to FIG. 6, and quantum dots were relatively uniformly dispersed in the PMMA matrix.

### Comparative Example 2

First, 1 wt % of quantum dot toluene solution (the mass ratio of red quantum dots to green quantum dots was 1:1.2) was taken, the first polymer particles (PMMA, having a molecular weight of about 100,000) and a first quantum dot toluene solution were mixed under stirring according to a mass ratio of 1,000:1, and at the same time, a toluene solvent was removed by vacuumizing to obtain polymer particles with the outer layer of the first polymer particles coated with quantum dots.

The red quantum dot materials used in the above examples and comparative examples were identical, and the green quantum dot materials were also identical, thereby facilitating comparison of results.

Preparation of a quantum dot diffusion plate:

First, 5% by mass of diffusion particles (titanium dioxide and silicon oxide) were mixed with a polymethylmethacrylate matrix blank material, and extrusion granulation was performed at 230° C. through an extrusion granulator to obtain first diffusion master batches used as raw materials of a first diffusion layer; 10% by mass of diffusion particles (titanium dioxide and silicon oxide) were mixed with the matrix blank material, and extrusion granulation was performed at 230° C. through an extrusion granulator to obtain second diffusion master batches used as raw materials of a second diffusion layer. The first diffusion master batches were mixed with the polymethylmethacrylate matrix blank material (the mass ratio was 10:100, and unless otherwise specified, the ratios in brackets below refer to mass ratios) and added into a first secondary extruder, the second diffusion master batches were mixed with the polymethylmethacrylate matrix blank material (10:100) and added into a second secondary extruder, a quantum dot particle aggregate (from Examples 1-3, Example 5 and Comparative Example 1) were added into a main extruder, the thicknesses of all the layers were controlled and adjusted to be 1:4:1, extrusion was conducted at 230° C. through a three-layer co-extrusion process, and roll-in cooling by using a roller (plain roller) and cutting was conducted to obtain the quantum dot diffusion plate.

First, 5% by mass of diffusion particles (titanium dioxide and silicon oxide) were mixed with a PS matrix blank material, and extrusion granulation was performed at 230° C. through an extrusion granulator to obtain first diffusion master batches used as raw materials of a first diffusion layer; 10% by mass of diffusion particles (titanium dioxide and silicon oxide) were mixed with the matrix blank material, and extrusion granulation was performed at 230° C. through an extrusion granulator to obtain second diffusion master batches used as raw materials of a second diffusion layer. The first diffusion master batches were mixed with the PS matrix blank material (the mass ratio was 10:100, and unless otherwise specified, the ratios in brackets below refer to mass ratios) and added into a first secondary extruder, the second diffusion master batches were mixed with the PS matrix blank material (10:100) and added into a second secondary extruder, a quantum dot particle aggregate (from Example 4) were added into a main extruder, the thicknesses of all the layers were controlled and adjusted to be 1:4:1, extrusion was conducted at 230° C. through a three-layer co-extrusion process, and roll-in cooling by using a roller (plain roller) and cutting was conducted to obtain the quantum dot diffusion plate.

Performance test was conducted on the quantum dot diffusion plates prepared above. The method for testing the luminous efficiency of the quantum dot diffusion plate is as follows: a 450 nm blue LED lamp was used as a backlight light source, a first diffusion layer was positioned away from the LED light source, and a second diffusion layer was positioned close to the LED light source. The spectrum of blue backlight and the spectrum of light passing through the quantum dot diffusion plate were tested separately by using an integrating sphere, and the luminous efficiency of the quantum dot diffusion plate was calculated by using an integral area of a spectrogram.

Luminous efficiency of diffusion plate=area of quantum dot emission peak/(area of blue backlight peak−area of blue peak unabsorbed after passing through the quantum dot diffusion plate)*100%.

The method for testing the luminous stability of the diffusion plate is as follows: changes in the luminous efficiency of the quantum dot diffusion plate were tested under the aging conditions of high temperature and blue light illumination (70° C., the wavelength of blue light of 450 nm, and the average light intensity of 0.5 W/cm²), high temperature and high humidity (65° C./95% relative humidity), high-temperature storage (85° C.) and the like. The initial efficiency in each of the examples and comparative examples was set to 100%.

TABLE 1

| | Luminous efficiency after 1,000 h aging (%) | | |
|---|---|---|---|
| | High | High | |
| | temperature | temperature | High- |
| | and blue light | and high | temperature |
| | illumination | humidity | storage |
| Example 1 | 80% | 81% | 82% |
| Example 2 | 93% | 92% | 94% |
| Example 3 | 85% | 88% | 87% |
| Example 4 | 96% | 97% | 95% |
| Example 5 | 92% | 91% | 92% |
| Comparative | 40% | 42% | 43% |
| Example 1 | | | |
| Comparative | 61% | 64% | 65% |
| Example 2 | | | |

It can be seen from Table 1 that the test results of accelerated aging in all the examples were better than those in the comparative examples, and there was a significant improvement in the lifetime of the light conversion device, which indirectly proves that the process can avoid or reduce the damage of high temperature to the quantum dots.

The quantum dot diffusion plates with the same dimension prepared from the materials of examples 1 to 5 and comparative example 1 were placed in the same backlight unit, and the chromaticity uniformity and luminance of the backlight unit were tested and recorded in Table 2, where CIE (x, y) represents a chromaticity coordinate value, 3×3 points with equal spacing were selected, deviation value of CIE-x=maximum value of CIE-x−minimum value of CIE-x, deviation value of CIE-y=maximum value of CIE-y−minimum value of CIE-y, and the smaller deviation value of CIE-x and deviation value of CIE-y indicate that the chromaticity uniformity of the backlight unit is better. Luminance uniformity=minimum luminance value in 9 points/maximum luminance value in 9 points, where the closer the luminance uniformity is to 1, the more uniform the luminance is; improved percentage of CIE-x chromaticity uniformity=(deviation value of CIE-x in comparative example 1−deviation value of CIE-x)/deviation value of CIE-x in comparative example 1; and improved percentage of CIE-y chromaticity uniformity=(deviation value of CIE-y in comparative example 1−deviation value of CIE-y)/deviation value of CIE-y in comparative example 1.

TABLE 2

| | | | | Improved | | Improved |
|---|---|---|---|---|---|---|
| | | | | percentage | | percentage |
| | | | CIE-x | of CIE-x | CIE-y | of CIE-y |
| | | Luminance | deviation | chromaticity | deviation | chromaticity |
| | Luminance/nit | uniformity | value | uniformity | value | uniformity |
| Example 1 | 1900 | 88% | 0.009 | 30.77% | 0.008 | 33.33% |
| Example 2 | 2500 | 89% | 0.006 | 53.85% | 0.007 | 41.67% |
| Example 3 | 2000 | 88% | 0.008 | 38.46% | 0.008 | 33.33% |
| Example 4 | 2600 | 90% | 0.005 | 61.54% | 0.004 | 66.67% |
| Example 5 | 2200 | 83% | 0.007 | 46.15% | 0.008 | 33.33% |
| Comparative | 1300 | 80% | 0.013 | — | 0.012 | — |
| Example 1 | | | | | | |
| Comparative | 1600 | 78% | 0.011 | — | 0.013 | — |
| Example 2 | | | | | | |

As can be seen from Table 2, in each of the examples, the luminance uniformity is improved and the chromaticity uniformity is greatly improved. The main reason is that the distribution uniformity of quantum dots in diffusion plates of the examples was better than that of the comparative examples. Regarding the mixed solution of quantum dots and the polymer in the examples, the quantum dots can be first dispersed and redistributed on the surfaces of polymer particles, and the uniformity of the quantum dots on the surfaces of the polymer particles is good. In Comparative Example 1, the quantum dot solution was directly used for granulation, where the quantum dot solution has a small amount relative to the blank material, and the dispersion effect in the extruder was poor; in comparative example 2, the polymer particles were directly coated with the quantum dot solution, and the viscosity of the quantum dot toluene solution was very low, so that the distribution uniformity of the quantum dots on the surfaces of the polymer particles was poor. The foregoing is merely illustrative of the preferred embodiments of the present disclosure and is not intended to limit the present disclosure, and various changes and modifications can be made to the present disclosure by those skilled in the art. Any modifications, equivalent replacements, improvements, etc. made within the spirit and principle of the present disclosure shall be included within the protection scope of the present disclosure.

What is claimed is:

1. A preparation method for a quantum dot particle aggregate, comprising: mixing a plurality of first polymer particles, a first quantum dot solution and a second polymer solution, and drying to obtain an aggregate containing a plurality of quantum dot particles A, wherein each of the quantum dot particles A comprises a core of a first polymer particle and a shell of a second polymer formed by the second polymer, a plurality of first quantum dots are positioned in the shell of the second polymer, and the first polymer particle has a minimum dimension greater than or equal to 0.3 mm.

2. The preparation method for the quantum dot particle aggregate of claim 1, further comprising: crushing the aggregate containing a plurality of quantum dot particles A to obtain the plurality of quantum dot particles A, mixing the plurality of quantum dot particles A and a third polymer solution, and drying to obtain an aggregate containing a plurality of quantum dot particles B, wherein each of the quantum dot particles B comprises a core of the quantum dot particle A and a shell of a third polymer formed by the third polymer.

3. The preparation method for the quantum dot particle aggregate of claim 1, further comprising: crushing the aggregate comprising a plurality of quantum dot particles A to obtain the plurality of quantum dot particles A, mixing the plurality of quantum dot particles A, a second quantum dot solution and a third polymer solution, and drying to obtain an aggregate containing a plurality of quantum dot particles B′, wherein each of the quantum dot particles B′ comprises a core of the quantum dot particle A and a shell of a third polymer formed by the third polymer, and a plurality of second quantum dots are positioned in the shell of the third polymer.

4. The preparation method for the quantum dot particle aggregate of claim 2, further comprising: crushing the aggregate containing a plurality of quantum dot particles B to obtain the plurality of quantum dot particles B, mixing the plurality of quantum dot particles B, a second quantum dot solution and a fourth polymer solution, and drying to obtain an aggregate containing a plurality of quantum dot particles C, wherein each of the quantum dot particles C comprises a core of the quantum dot particle B and a shell of a fourth polymer formed by the fourth polymer, and a plurality of second quantum dots are positioned in the shell of the fourth polymer.

5. The preparation method for the quantum dot particle aggregate of claim 4, wherein the fourth polymer comprises one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer, and polyethylene terephthalate.

6. The preparation method for the quantum dot particle aggregate of claim 3, wherein the second quantum dot solution comprises 0.1 wt % to 5 wt % of the second quantum dots, and the second quantum dots are the same as or different from the first quantum dots.

7. The preparation method for the quantum dot particle aggregate of claim 1, wherein a mass ratio of the plurality of first polymer particles to the second polymer is 100:1 to 100:10, and a mass ratio of the first quantum dots to the second polymer is 0.1:100 to 5:100.

8. The preparation method for the quantum dot particle aggregate of claim 1, wherein the first quantum dot solution comprises 0.1 wt % to 5 wt % of the first quantum dots.

9. The preparation method for the quantum dot particle aggregate of claim 1, wherein the first polymer particle has a shape of a cylinder or a cuboid.

10. The preparation method for the quantum dot particle aggregate of claim 1, wherein the first polymer particle comprises one or more of polystyrene, polymethylmethacrylate, polypropylene, polyethylene, an acrylonitrile-styrene copolymer, a methyl methacrylate-styrene copolymer, polycarbonate, and polyethylene terephthalate.

11. The preparation method for the quantum dot particle aggregate of claim 2, wherein the second polymer or the third polymer comprises one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer, and polyethylene terephthalate.

12. A preparation method for a light conversion device, comprising: obtaining the quantum dot particle aggregate according to the preparation method of any one of claim 1, subjecting the quantum dot particle aggregate to crushing treatment or not, melt-extruding, and solidifying and molding to obtain the light conversion device.

13. A quantum dot particle, comprising a core of a first polymer particle and a shell of a second polymer, wherein a plurality of first quantum dots are positioned in the shell of the second polymer, and the first polymer particle has a minimum dimension greater than or equal to 0.3 mm.

14. The quantum dot particle of claim 13, wherein the core of the first polymer particle is non-chemically bonded to the shell of the second polymer.

15. The quantum dot particle of claim 13, further comprising a shell of a third polymer, wherein the shell of the third polymer is positioned outside the shell of the second polymer.

16. The quantum dot particle of claim 13, further comprising a shell of a third polymer, wherein the shell of the third polymer is positioned outside the shell of the second polymer, and a plurality of second quantum dots are positioned in the shell of the third polymer.

17. The quantum dot particle of claim 15, further comprising a shell of a fourth polymer, wherein the shell of the fourth polymer is positioned outside the shell of the third polymer.

18. The quantum dot particle of claim 13, wherein the quantum dot particle has a fluorescence quantum efficiency greater than or equal to 90%, and the quantum dot particle has a full-width at half maximum (FWHM) less than or equal to 25 nm.

19. The quantum dot particle of claim 13, wherein the first polymer is the same as or different from the second polymer.

20. The quantum dot particle of claim 15, wherein the second polymer is the same as or different from the third polymer.

21. The quantum dot particle of claim 17, wherein the first polymer particle comprises one or more of polystyrene, polymethylmethacrylate, polypropylene, polyethylene, an acrylonitrile-styrene copolymer, a methyl methacrylate-styrene copolymer, polycarbonate, and polyethylene terephthalate; the second polymer or the third polymer comprises one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer and polyethylene terephthalate; and the fourth polymer comprises one or more of polystyrene, polymethylmethacrylate, polypropylene, polyethylene, an acrylonitrile-styrene copolymer, polycarbonate, a methyl methacrylate-styrene copolymer, polyvinyl alcohol, an ethylene-vinyl alcohol copolymer and polyethylene terephthalate.

22. (canceled)

23. (canceled)

24. (canceled)
